(19) United States
(12) Patent Application Publication
(10) Pub. No.: US 2015/0199916 A1
(43) Pub. Date: Jul. 16, 2015

(54) VISION RESTRICTING APPARATUS FOR SPORTS TRAINING

(71) Applicant: Adam Spangenthal, Palm Beach Gardens, FL (US)

(72) Inventor: Adam Spangenthal, Palm Beach Gardens, FL (US)

(21) Appl. No.: 14/154,664

(22) Filed: Jan. 14, 2014

(51) Int. Cl. G09B 19/00

(52) U.S. Cl. CPC G09B 19/0038

(57) ABSTRACT

A vision restricting apparatus is provided for obstructing the view of wearer feet and legs and lowered hands and of an area of ground immediately in front of the wearer feet to train the wearer to react without looking at this area the apparatus including a vision blocking barrier; and barrier mounting mechanism for mounting the barrier to a garment to extend forwardly from the garment front a sufficient distance to prevent the wearer from seeing the area of ground immediately in front of his or her feet. The apparatus additionally includes a garment having a garment front and a garment back and having a garment pocket, where the vision blocking barrier includes a block of material removably fit into the panel pocket and protruding forwardly from the garment front. The pocket is elongate and oriented generally horizontally across the garment front, and open at one pocket end and the block is sized to snugly and readily slide into and out of the pocket and define a vision barrier.

### FILING HISTORY

This application continues from application Ser. No. 61/765,504 filed on Feb. 15, 2013.

### BACKGROUND OF THE INVENTION

1. Field of the Invention

The present invention relates generally to the field of sports training equipment. More specifically the present invention relates to a vision restricting apparatus for obstructing the view of the wearer feet and legs and in some instances obstructing hands when hands are lowered such as when dribbling a ball, as well as of a pre-determined area of ground immediately in front of the wearer and thus of a ball or puck entering this area, to train the wearer to react to a ball such as soccer ball or basketball without looking at the ball after it has entered this area. This area, known as the “area of control”, is the area of ground immediately in front of the wearer feet, and preferably the area from the wearer toes rearward. The apparatus includes a vision blocking barrier which preferably is opaque and a barrier mounting means for mounting the barrier to a garment such as a shirt, pinnie or jersey to extend forwardly from the front fabric sheet of a garment body, hereinafter the garment front, a sufficient distance to prevent the wearer from seeing the predetermined area of ground referred to herein, as noted above, as the area of control. The barrier may be permanently attached to the garment front such as with a suitable glue or other adhesive or removably attached with hook and loop fasteners, but preferably is removably attached by placement of the barrier into an open pocket as below described. Most or all of the apparatus, and at least the vision blocking barrier, are formed of soft and preferably resilient and light weight material such as foam rubber, soft plastics, or a liquid or air filled bladder, so that impact with another player, the ground or other object will not cause injury, and so that the apparatus automatically resumes its initial configuration after impact. Alternatively, and to achieve the same objectives, the apparatus may be formed of thin, soft sheets forming pockets which can be filled with soft, resilient material or inflated.

As noted above, the barrier preferably includes a pocket secured to or within the garment front and a barrier in the form of a block such as a piece of foam retained either removably or permanently in the pocket for barrier deployment. The block may have any of various lateral cross-sectional shapes such as rectangular, square or semicircular. The pocket preferably is elongate and oriented generally horizontally across the garment front, and is open at one and preferably both longitudinal pocket ends. The block preferably is elongate and sized in length and width to loosely and readily slide into and out of the pocket, and to protrude forwardly within the pocket from the garment front a suitable distance as described herein to optimally perform its barrier function of obstructing the wearer view of a pre-determined area of ground. The block fits loosely into the pocket so that it can float freely within the pocket and can he worn by players having different chest sizes and be suited for both male and female players. The block preferably has a semi-circular cross-section and is oriented in the pocket so that the curved portion protrudes forwardly and causes the barrier to have a semi-circular shape, and a flat rearward face Which rests flat adjacent to the wearer chest. The forwardly protruding, semi-circular shape assures that there are no harsh corners to make contact with another player. To blunt any end corners, the opposing longitudinal block ends preferably are angled or beveled inwardly from rearward face to forward face. To conserve foam material and to make the block lighter, a series of holes preferably are molded or cut through the block such as from front to back as shown.

The vision blocking harrier alternatively takes the form of a rectangular barrier panel, and the barrier mounting means preferably includes at least one and preferably two L-shaped brackets at each lateral end of the barrier panel for mounting the panel generally perpendicularly to a front, each bracket being formed of soft and preferably resilient material. The brackets preferably are formed of what might be referred to as “springy rods”. The forward extent of the panel preferably is 3-6 inches and typically 4 inches from the garment front and the lateral extent of pad 20 being substantially the width of the wearer chest, but it is contemplated that any of a wide variety of panel dimensions may be provided, to achieve any desired extent of vision obstruction. The resilience of the bracket material not only restores the bracket to its initial shape after impact, but also permits the barrier panel to be manually pivoted downwardly or upwardly against the biasing of the bracket resilient material into face to face contact with the garment front. One leg of each L-shaped bracket, namely a substantially horizontal leg, protrudes forwardly into, or is fastened to the lower surface of the barrier panel, and the other leg, namely a substantially vertical leg, is connected to and extends either upwardly or downwardly from the rearward end of the horizontal leg and fastens to the garment front.

A barrier anchor mechanism preferably is provided for releasibly securing the barrier panel flat abutting relationship to the garment front against the biasing of the barrier mounting means, so that the barrier panel can be deployed exclusively when desired.

For a first embodiment, the barrier mounting means such as the pair of horizontal legs of the brackets is fastened during manufacture to the garment front substantially at mid-chest above the xiphoid and below the sternal notch, so that the garment and apparatus become a single unit. For a second embodiment, the apparatus is provided as an after-market item for attachment to an existing garment at varying chest levels.

2. Description of the Prior Art

There has long been a recognized need to train soccer, hockey and other sports players to react and initiate control action without looking down at the ball or puck, or at the ball or puck as it reaches their feet. To aid in such training, glasses or goggles have been provided which include structure protruding forwardly from the frame below each wearer eye to obstruct the wearer view of the wearer feet and legs and the ground immediately in front of the wearer feet. An example of this is the WRAP GOGGLES SPORTS GLASSES™ found on P-BUY.COMTM, Item ID 10149. A problem with these prior devices is that they may cause facial injuries when sports participants contact each other. In addition, when the head of a participant wearing glasses is not perfectly level, he or she is forced to compensate for the loss of forward field vision by unnaturally moving the head and neck in anatomically and bio mechanically unbalanced and unnatural positions. Therefore the glasses may be otherwise restrictive in unintended ways, diminishing the wearer's performance.

it is thus an object of the present invention to provide a vision restricting apparatus which blocks the wearer view of the area of control of a ball or puck which may be defined to include his or her feet, legs and/or arms and, where desired, of an area of ground immediately in front of the wearer feet, but preferably the area from the wearer toes rearward, to train the wearer to play a sport such as soccer without looking at this area.

It is another object of the present invention to provide such a vision restricting apparatus which can be deployed to block such a wearer view only at times when desired and retracted to restore the full range of vision when not desired while the apparatus is worn.

It is still another object of the present invention to provide such a vision restricting apparatus which is formed of soft materials and which safely collapses or compresses upon impact with another person, the ground or an object and immediately restores its shape and associated vision blocking function in order to both prevent injury to the wearer or to another person and continue to function as a vision blocking device.

It is yet another object of the present invention to provide such a vision restricting apparatus which can be provided as part of a garment, and alternatively can be secured to any existing garment or directly to the wearer absent a garment.

It is finally an object of the present invention to provide such a vision restricting apparatus which is easy to use, can be operated quickly, is compact for storage and transport and inexpensive to manufacture.

### SUMMARY OF THE INVENTION

The present invention accomplishes the above-stated objectives, as well as others, as may be determined by a fair reading and interpretation of the entire specification.

A vision restricting apparatus is provided for obstructing the view of wearer feet and legs and of an area of ground immediately in front of the wearer feet to train the wearer to rent without looking at this area, the apparatus including a vision blocking barrier; and barrier mounting mechanism for mounting the barrier to a garment to extend forwardly from the garment front a sufficient distance to prevent the wearer from seeing the area of control.

The apparatus preferably additionally includes a garment having a garment front and a garment back and having a garment pocket, where the vision blocking barrier includes a block of material removably fit into the panel pocket and protruding forwardly from the garment front. The block preferably includes at least one piece of plastic foam. The block preferably is one of rectangular, square and semi-circular in lateral cross-section.

The garment pocket preferably has longitudinal first and second pocket ends, and the pocket preferably is elongate and oriented generally horizontally across the garment front, and open at one or more longitudinal pocket ends and the block is elongate and sized in length and width to readily slide into and out of the pocket, and to protrude forwardly within the pocket from the garment front a suitable distance to perform its barrier function. The block preferably is sized relative to the pocket to fit loosely into the pocket.

The block preferably has a substantially semi-circular lateral cross-section and is oriented in the garment pocket to protrude forwardly and cause the barrier to have a semi-circular shape, and has a substantially planar rearward face which rests flat adjacent to the chest of a wearer, so that the forwardly protruding, substantially semi-circular shape assures that there are no sharp corners to make contact with another player. The block preferably has opposing block longitudinal ends which are angled inwardly from the block rearward face to the block forward face. The apparatus block preferably includes one of holes and recesses so that block material is conserved and the block is lighter. The block preferably includes one of a single mass of solid material such as rubber; a hollow shell; a series of fragmented pieces of solid material contained within a hollow container; an expandable bladder which can be filled with one of a liquid, small solids and air.

Such an apparatus is further provided for obstructing the view of the wearer feet and legs, and in some instances wearer hands, or of a stick and of an area of ground immediately in front of the wearer feet to train the wearer to react and control without looking down at this area, the apparatus including a vision blocking harrier which is soft and readily compressible, collapsible and resilient; and a barrier mounting means for mounting the barrier to a garment to extend forwardly from the garment front a sufficient distance to prevent the wearer from seeing the area of control.

The vision blocking barrier preferably is formed of material that is both soft and resilient. The vision blocking structure preferably includes a rectangular barrier panel. The barrier mounting means preferably includes at least two L-shaped brackets spaced laterally apart from each other mounting the panel generally perpendicularly to a garment front. Each bracket preferably is formed of soft and resilient material. A semicircular or square space occupying barrier formed of soft resilient material may also he placed in or on a garment front.

The pocket, as an example only, may he between 4 and 5 inches in vertical width and the block may have a vertical width between 2 and 4 inches, so that the block floats within the pocket.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a front, perspective view of a participant wearing a jersey equipped with the first embodiment of the present vision restricting apparatus including a jersey pocket and a barrier in the form of a horizontally elongate block inserted into the garment pocket.

FIG. 2 is a front, perspective view of the jersey having the substantially horizontal garment pocket of the first preferred embodiment, again containing the elongate block.

FIG. 3 is a view as in FIG. 2 additionally showing the elongate block positioned for insertion and partly inserted into the garment pocket.

FIG. 4 is a view as in FIG. 3 showing the elongate block fully inserted into the garment pocket.

FIG. 5 is a perspective view of the preferred block as in FIG. 1.

FIG. 6 is a front, perspective view of the second preferred embodiment of the present vision restricting apparatus mounted to a jersey.

FIG. 7 is a view as in FIG. 6 showing a participant wearing the jersey.

FIG. 8 is a view as in FIG. 6 of the third preferred embodiment having hook and loop fastener releasable barrier mounting means.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### The Invention Generally

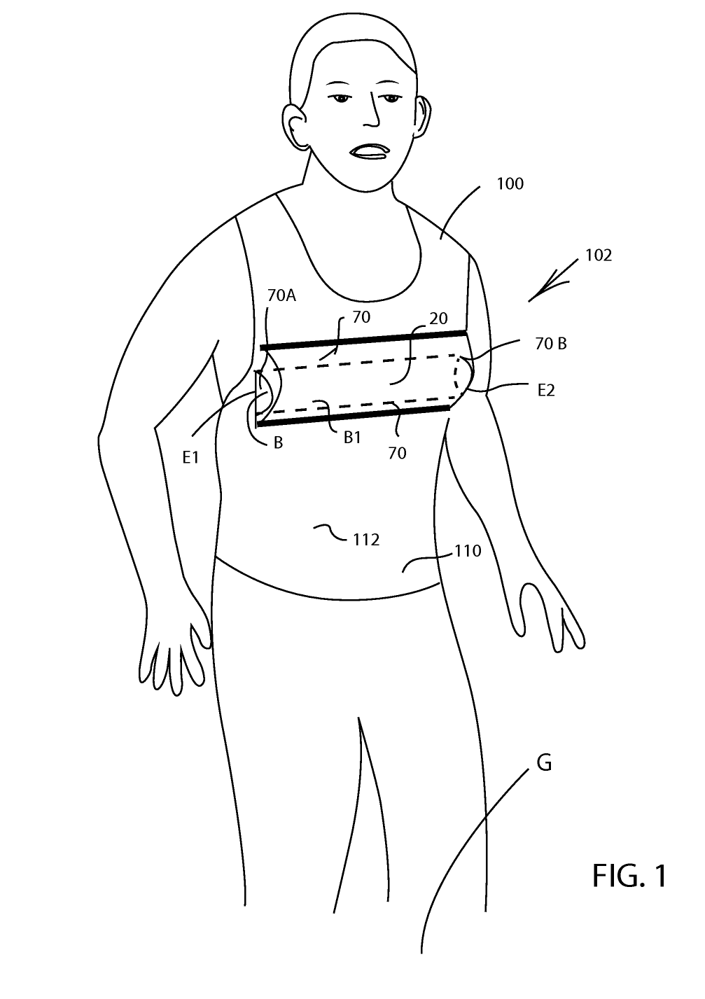

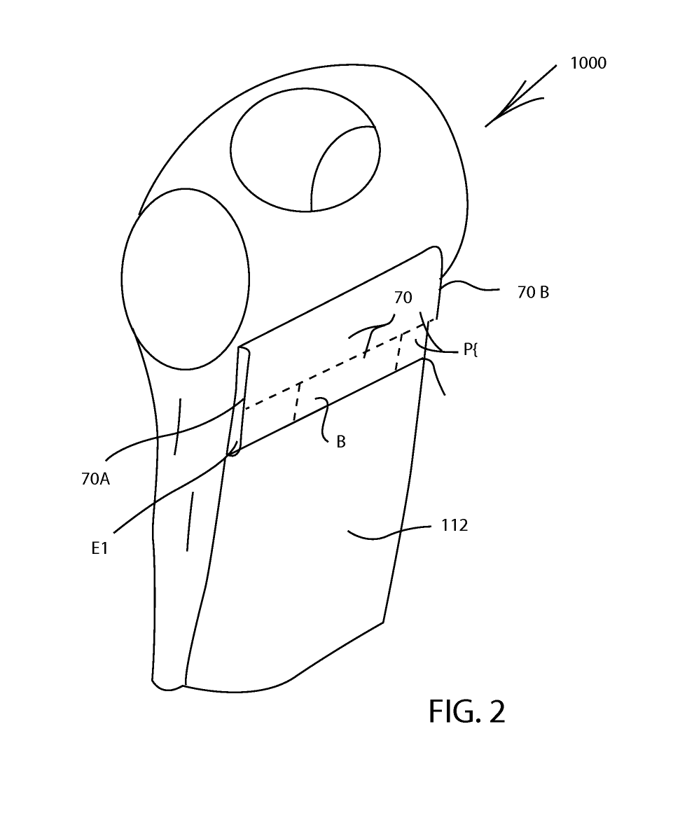

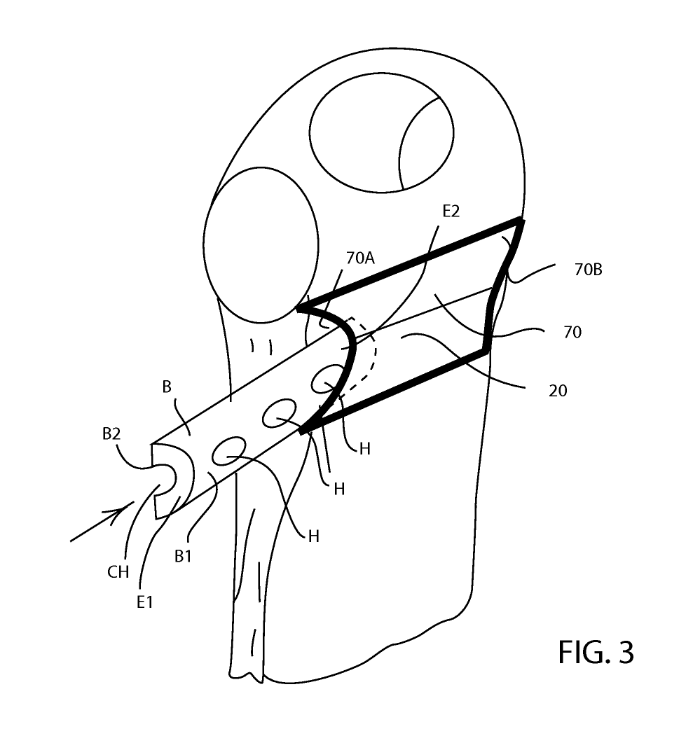

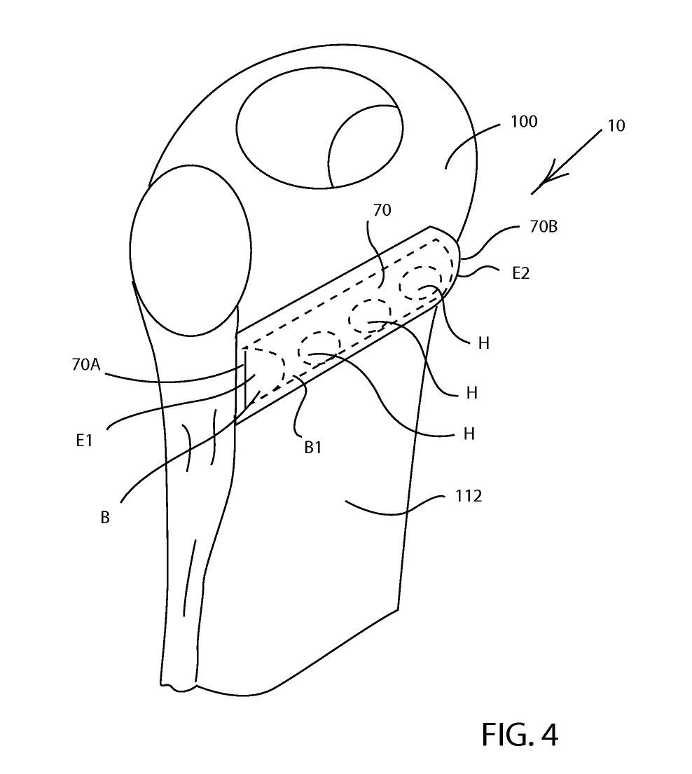

Referring to FIGS. 1-8, a vision restricting apparatus 10 is disclosed for obstructing the view of the feet and legs of the wearer of apparatus 10, as well as of a pre-determined area of ground G immediately in front of the wearer and thus of a ball such as a soccer hall or a puck after entering this area, to train the wearer to react and control the ball or puck without looking at his or her feet or legs or at the ball or puck itself after it has entered this area. This area, known as the “area of control”, is the area of ground immediately in front of the wearer feet, and preferably the area from the wearer toes rearward.

The apparatus 10 includes a vision blocking barrier 20 which preferably is opaque and a barrier mounting means 40 for mounting the barrier 20 to a garment 100 such as a shirt, pixie or jersey having a garment body 110 including a sheet forming the garment front 112 and a garment back 114, to extend forwardly from the garment front 112 a sufficient distance to prevent the wearer from seeing the predetermined area of ground G. Most or all of apparatus 10, and at least the vision blocking barrier 20, are formed of soft and preferably resilient and light weight material such as foam rubber so that impact with another player, the ground or other object will not cause injury, and so that the apparatus 10 automatically resumes its initial configuration following impact. Alternatively, and to achieve these same objectives, apparatus 10 may be formed of thin, soft sheets forming pockets which can be deployed through inflation to remain impact safe and resilient.

### First Preferred Embodiment

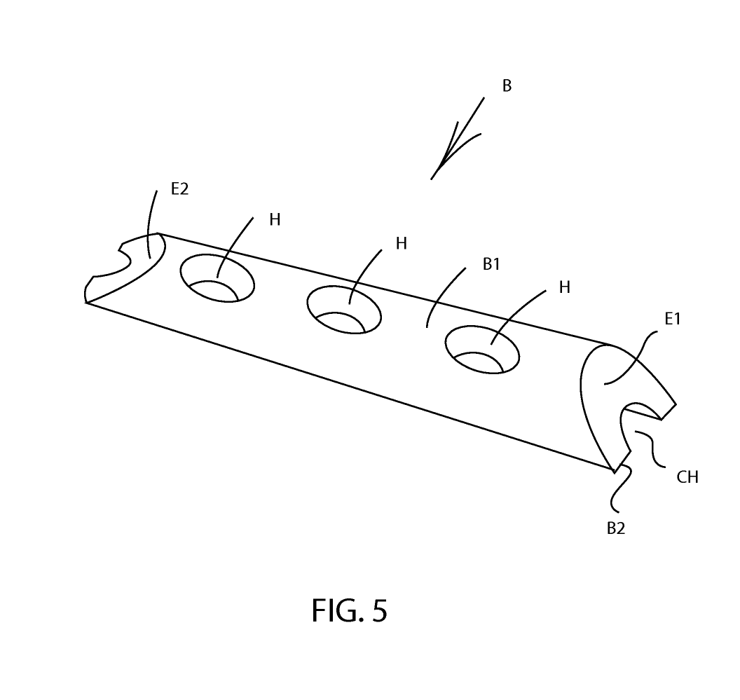

For a first embodiment, the barrier 20 includes a pocket 70 secured to or within the garment front 12 and a barrier 20 in the form of a block B such as a piece of foam removably fit into the panel pocket 70 for barrier 20 deployment. See FIGS. 1-5. The block B may have any of various lateral cross-sectional shapes such as rectangular, square or semi-circuit. The pocket 70 preferably is elongate and oriented generally horizontally across the garment front 12, and preferably sized to extend across the full width of the garment front 12, and is open at one and preferably both longitudinal pocket ends 70A and 70B. The block B preferably is elongate and sized in length and width to loosely and readily slide into and out of the pocket 70, and to protrude forwardly within the pocket. 70 from the gall. rent front 112 a suitable distance as described herein to optimally perform its barrier 20 function of obstructing the wearer view of a pre-determined area of ground G. The block B fits loosely in the pocket 70 so that it can float within the pocket 70 and therefore can be worn by players having different chest sizes and be suited for both male and female players. The block B preferably has a semi-circular cross-section and is oriented in the pocket 70 so that the curved portion to protrudes forwardly and causes the barrier 20 to have a semi-circular shape, and a flat rearward face B2 which rests flat adjacent to the wearer chest. The forwardly protruding, semi-circular shape assures that there are no harsh corners to make contact with another player. To blunt any end corners, the opposing longitudinal block ends BE1 and BE2 of the block B preferably are angled or beveled inwardly from rearward face 132 to forward face B1. To conserve foam material and to make the block B lighter, a series of holes H preferably are molded or cut through the block B such as from front to back as shown. See FIG. 5. Another example of a material conserving cutaway is a semicircular longitudinal channel CH recessed into the flat rearward face B2 of the block B.

Alternatively, the block B may be a solid block such as of rubber, a hollow shell, a series of fragmented pieces or granules of material inside a hollow shell, an expandable bladder which can be filled with liquid, small soft solids or air the garment front 112, and a soft plate 72. The block B may have one or more holes H in it or through it or block B may have no boles.

### Second Preferred Embodiment

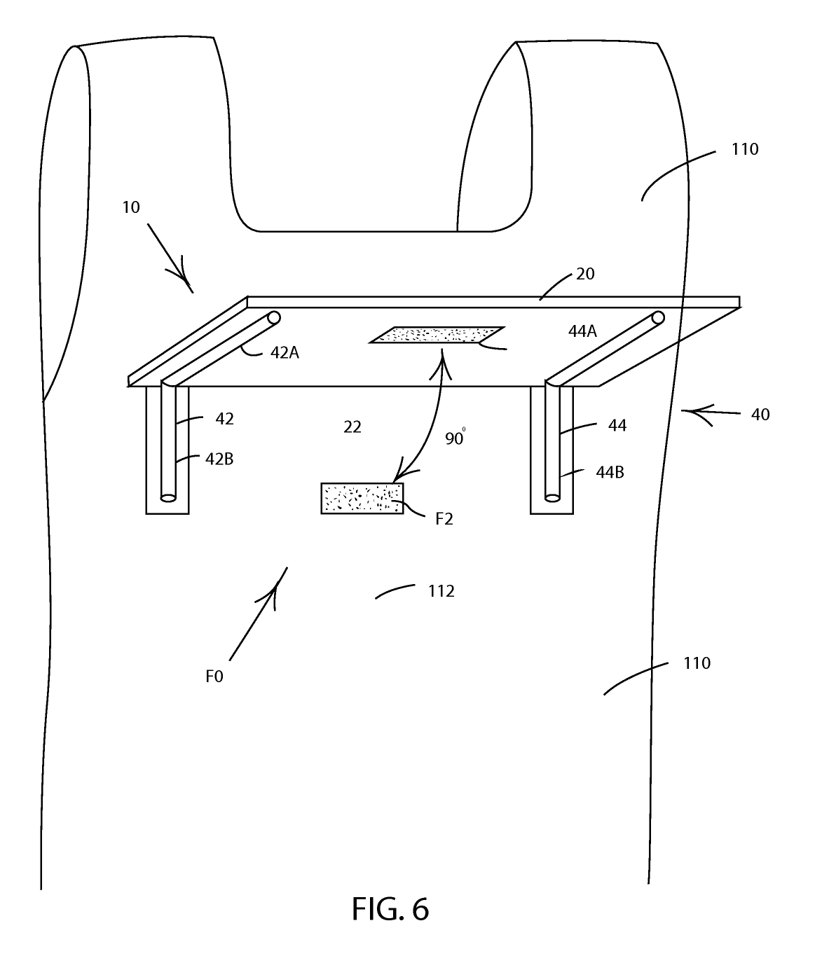

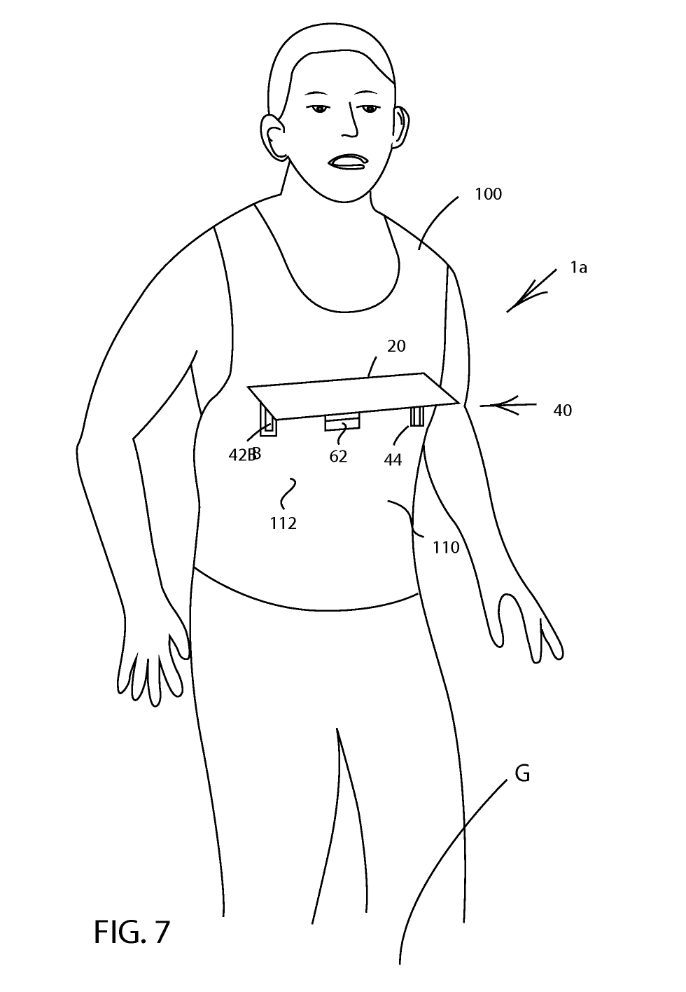

The vision blocking barrier 20 alternatively takes the form of a rectangular barrier panel 20, and the barrier mounting means 40 preferably includes at least one and preferably two L-shaped brackets 42 and 44 at each lateral end of the barrier panel 20 for mounting the panel 20 generally perpendicularly to a garment front 112, each bracket 42 and 44, once again, being formed of soft and preferably resilient material. See FIGS. 6 and 7. The brackets 47 and 44 preferably are formed of what might be referred to as “springy rods”. The forward extent of the panel 20 from the wearer chest or garment front 112 preferably is 3-6 inches and typically 4 inches and the lateral extent of panel 20 being substantially the width of the wearer chest, but it is contemplated that any of a wide variety of panel 20 dimensions may be provided, to achieve any desired extent of vision obstruction of any desired area of ground G. The resilience of the bracket 42 and 44 material not only restores the bracket to its initial shape after impact, but also permits the barrier panel 20 to he manually pivoted downwardly (or upwardly) against the biasing of the bracket resilient material into face to face contact with the garment front 112. One leg of each L-shaped bracket 42 and 44, namely a substantially horizontal leg 42A or 44A, protrudes forwardly into, or is fastened to the lower surface of the barrier panel 20, and the other leg, namely a substantially vertical leg 42B or 44B, is connected to and extends either upwardly or downwardly from the rearward end of the horizontal log 42A or 44A and fastens to the garment front 112.

A barrier anchor mechanism 60 preferably is provided for releasibly securing the barrier panel 20 in flat abutting relationship to the garment front 112 against the biasing of the barrier mounting means 40, so that the barrier panel 20 can be deployed exclusively when desired. The preferred barrier anchor mechanism 60 includes a first hook and loop fastener patch 62 secured to garment front 112 and a second hook and loop fastener patch 64 secured to the barrier panel lower surface 22, the first and second hook and loop fastener patches 62 and 64, respectively, being positioned relative to each other such that the second fastener patch 64 registers with and makes face-to-face contact the first fastener patch 62 when the barrier panel 20 is pivoted against the garment front 112. Alternatively the barrier anchor mechanism 60 can be a suitable glue or adhesive for permanently securing the harrier panel 20 to the garment 112.

For a first embodiment, the barrier mounting means 40 such as the pair of horizontal legs 42A and 44A of the brackets 42 and 44, respectively, is fastened during manufacture to the garment front 112 substantially at wearer nipple level, so that the garment 100 and apparatus 10 become a single unit. For a second embodiment, the apparatus 10 is provided as an after-market item for attachment to an existing garment 100. Such after-market attachment may he achieved by garment honk and loop fastener patches 46 and 48, except that they are not initially secured to the garment 100 and are therefore secured to a garment of choice after purchase, to which the vertical legs 42A and 44A are secured such as by a waterproof adhesive. See FIG. 1.

### Third Preferred Embodiment

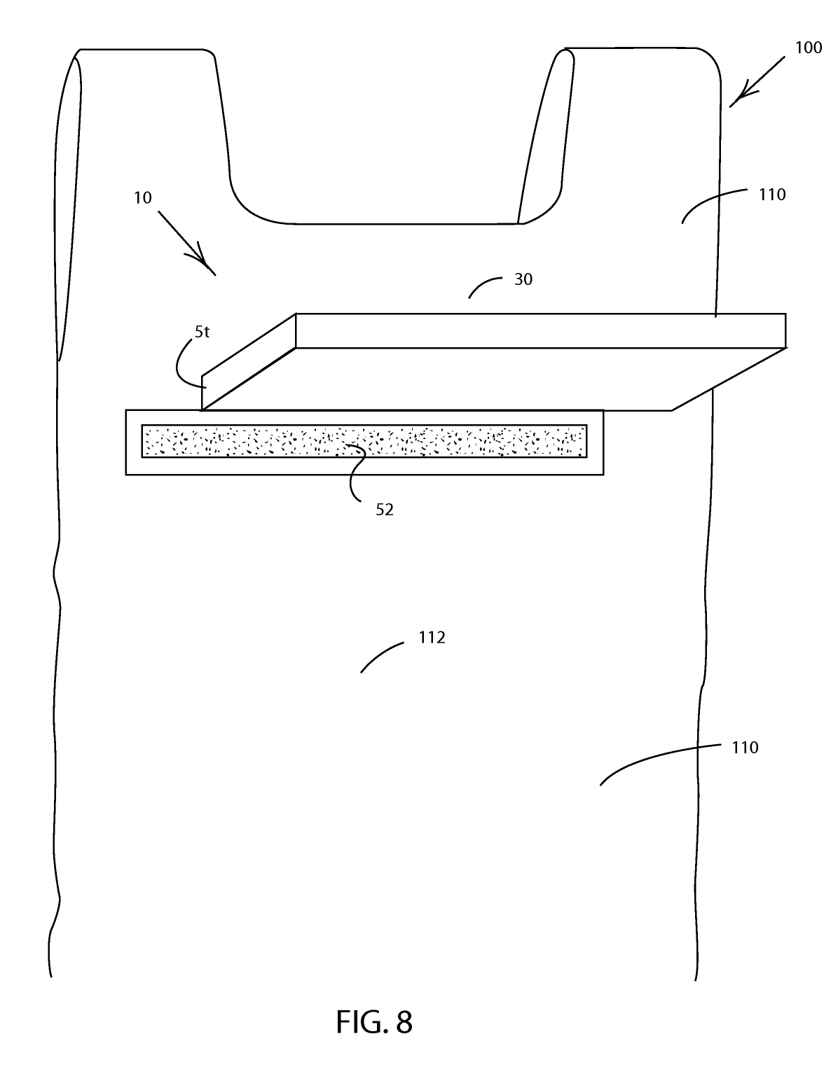

For a third embodiment, the panel 20 is preferably of a thick soft thorn and has a panel hook and loop fastener patch 54 on its panel rearward edge 24, which removably fastens to a garment hook and loop fastener patch 52 secured to the garment front 112. See FIG. 8, The barrier panel 20 is thicker to be, in the absence of brackets 42 and 44, a self-supporting forwardly protruding cantilever structure. The barrier panel 20 is deployed by placing the panel rearward edge 24 firmly against the garment hook and loop fastener patch 52 so that the fastener patches 52 and 54 mutually engage. When not deployed, panel 20 is simply removed by pulling it away from the garment front 112. Alternatively, the panel 20 can be permanently secured to the garment 112 with a suitable glue or adhesive.

Finally, as yet another contemplated embodiment, apparatus 10 may be secured directly to the wearer with or without a garment, such as with a strap to which the barrier panel 20 is fastened, the strap being wrapped around the player torso and removably secured such as with a buckle or snap used in a woman's brassier, or directly attached to the chest with a material such as VELCRO™ or within the garment in a horizontal pouch located on the chest.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A vision restricting apparatus for obstructing the view of the wearer feet and legs and lowered hands and of an area of ground immediately in front of the wearer feet to train the wearer to react without looking at this area, comprising:
a vision blocking barrier;
and barrier mounting means for mounting the barrier to a garment to extend forwardly from the garment front a sufficient distance to prevent the wearer from seeing the area of ground immediately in front of his or her feet,

2. The apparatus of claim 1, additionally comprising a garment having a garment front and a garment back and having a garment pocket, wherein said vision blocking barrier comprises a block of material removably fit into said panel pocket and protruding forwardly from said garment front.

3. The apparatus of claim 2, wherein said block comprises at least one piece of plastic foam.

4. The apparatus of claim 2, wherein said block is one of rectangular, square and semi-circular in lateral cross-section.

5. The apparatus of claim 2, having longitudinal first and second pocket ends, wherein said pocket is elongate and oriented generally horizontally across said garment front, and open at one or more longitudinal pocket ends and wherein said block is elongate and sized in length and width to readily slide into and out of said pocket, and to protrude forwardly within said pocket from said garment front a suitable distance to perform its harrier function.

6. The apparatus of claim 2, wherein said block has a substantially semi-circular lateral cross-section and is oriented in said garment pocket to protrude forwardly and cause said barrier to have a semi-circular shape, and has a substantially planar rearward face which rests flat adjacent to the chest of a wearer, such that the forwardly protruding, substantially semi-circular shape assures that there are no sharp corners to make contact with another player.

7. The apparatus of claim 5, wherein said block has opposing block longitudinal ends which are angled inwardly from the block rearward face to the block forward face.

8. The apparatus of claim 2, wherein said block comprises one of holes and recesses such that block material is conserved and the block is lighter.

9. The apparatus of claim 2, wherein said block comprises one of a single mass of solid material; a series of fragmented pieces of solid material contained within a hollow container; an expandable bladder which can be filled with one of a liquid, small solids and air.

10. The apparatus of claim 1, wherein said vision blocking barrier is formed of material that is soft and readily collapsible and resilient.

11. The apparatus of claim 1, wherein said vision blocking barrier comprises a rectangular barrier panel.

12. The apparatus of claim 11, wherein said barrier mounting means comprises at least two L-shaped brackets spaced laterally apart from each other mounting the panel generally perpendicularly to a garment front.

13. The apparatus of claim 12, wherein each said bracket being formed of soft and resilient material.

14. The apparatus of claim 11, wherein the forward extent of said barrier panel preferably is between 3 inches and 6 inches.

15. The apparatus of claim 12, wherein each said bracket comprises a substantially horizontal leg supportingly connected to said barrier panel for protruding forwardly from the wearer chest and a substantially vertical leg connected to and extending along the wearer chest and one of upwardly and downwardly from said harrier panel, and which fastens to said garment front.

16. The apparatus of claim 15, the resilience of the bracket material not only restores each said bracket to its initial shape after impact, but also permits the barrier panel to be manually pivoted downwardly against the biasing of the bracket material.

17. The apparatus of claim 16, additionally comprising a barrier anchor mechanism for releasibly securing the panel flatly abutting the garment front against the biasing of the barrier mounting means, such that said barrier can be deployed when desired.

18. The apparatus of claim 17, wherein said panel has a panel lower surface, comprising:
a first hook and loop fastener patch secured to said garment front; and a second hook and loop fastener patch secured to the lower surface of said panel surface, said first and second hook and loop fastener patches being positioned relative to each other such that the second patch registers with and makes face to face contact the first patch when the panel is pivoted against the garment front.

19. The apparatus of claim 5, wherein said block is sized relative to said pocket to fit loosely into said pocket.

20. A vision restricting apparatus for obstructing the view of the wearer feet and legs and lowered hands and of an area of ground immediately in front of the wearer feet to train the wearer to react without looking at this area, comprising:
a vision blocking barrier to be worn by a wearer with barrier mounting means for mounting the barrier to protrude forwardly from the front of a wearer.
